(19) United States
(12) Patent Application Publication
(10) Pub. No.: US 2008/0261531 A1
(43) Pub. Date: Oct. 23, 2008

(54) SYSTEM AND METHOD FOR PROVIDING COVERAGE AND SERVICE CONTINUATION IN BORDER CELLS OF A LOCALIZED NETWORK

(75) Inventors: Leping Huang, Tokyo (JP); Hongyuan Chen, Inagi-shi (JP); Kodo Shu, Miyamae-ku (JP)

Correspondence Address: FOLEY & LARDNER LLP, P.O. BOX 80278, SAN DIEGO, CA, 92138-0278, US

(73) Assignee: Nokia Corporation

(21) Appl. No.: 12/103,614

(22) Filed: Apr. 15, 2008

Related U.S. Application Data
(60) Provisional application No. 60/912,107, filed on Apr. 16, 2007.

(51) Int. Cl. H04B 1/00

(52) U.S. Cl. 455/63.1

(57) ABSTRACT

A system and method for providing continuous multimedia broadcast multicast services over different localized areas, while also avoiding frequency interference. In various embodiments, a service provides reduced-quality data at the border of each localized area. In one approach, border cells of a single frequency network (SFN) broadcast reduced quality data, while more centralized cells in a SFN broadcast full quality data. In other embodiments, source data is coded by two layers—a baseline layer and at least one enhancement layer. Centralized cells in a SFN transmit both baseline and enhancement layers. Border cells broadcast only the baseline layer. Centralized cells and border cells use the same sub-band to broadcast baseline layer data in a bit-identical way. Non-overlapping sub-bands are used by border cells of neighboring SFNs to transmit the baseline layer.

### FIELD OF THE INVENTION

The present invention relates generally to multimedia broadcast multicast services (MBMS). More particularly, the present invention relates to service continuation for MBMS services at the border of single frequency networks (SFNs).

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Universal Mobile Telecommunications System (UMTS) is a 3G mobile communication system which provides a variety of multimedia services. The UMTS Terrestrial Radio Access Network (UTRAN) is a part of a UMTS network which includes one or more radio network controllers (RNCs) and one or more nodes. Evolved UTRAN (E-UTRAN), which is also known as Long Term Evolution or LTE, provides new physical layer concepts and protocol architectures for UMTS.

Streaming applications such as mobile digital TV may become a significant application in LTE MBMS in the future. Currently, the use of layered coding is a common method of transmitting video streams over the Internet in order to adapt to changes of path delay, path bandwidth and path error thereon. Satisfactory rate scalability of the streaming can be elegantly achieved by scalable video codecs that provide layered embedded bit-streams that are decodable at different bitrates, with gracefully degrading quality. In addition to layered representations for Internet streaming, scalable representations have become part of established video coding standards such as the Moving Picture Experts Group (MPEG) and H.263+ standards. Scalable video representations aid in Transmission Control Protocol (TCP)-friendly streaming, as they provide a convenient mechanism for performing the rate control that is necessary to mitigate network congestion.

In receiver-driven layered multicasting, video layers are sent in different multicast groups, and rate control is performed individually by each receiver by subscribing to the appropriate groups. Layered video representations have further been proposed in combination with differentiated quality of service (Diffserv) in the Internet. The idea behind this proposal is to transmit the more important layers with better, but more expensive, quality of service (QoS), and the less important layers would be transmitted with fewer or no QoS guarantees.

A scalable representation of a video signal comprises a base layer and one or more enhancement layers. The base layer provides a basic level of quality and can be decoded independently. On the other hand, the enhancement layers only serve to refine the base layer quality. As such, enhancement layers are typically not useful by themselves. For this reason, the base layer represents the most critical part of a scalable representation, which makes the performance of streaming applications that employ layered representations sensitive to the loss of base layer packets.

It is generally assumed that MBMS services operate with a synchronized SFN. In the event that a service provider wishes to provide nation-wide service and does not form a nation-wide SFN, it can instead first form localized SFNs from multiple cells, and then form a nation-wide broadcast network from these multiple localized asynchronized SFNs. In this arrangement, the same MBMS services are provided in every localized SFN. However, issues arise when a user moves between SFNs. The issues that arise are similar to those that currently exist in analog broadcast television. With analog broadcast television, users have to change channels or frequencies when they move across the border of two broadcast areas. However, this problem is much more pronounced in LTE-MBMS systems, as one SFN area in LTE-MBMS will typically be much smaller than a conventional digital/analog broadcasting service coverage area.

According to the current LTE-MBMS proposal, different SFNs are to be planned in the same frequency (involving a frequency reuse mechanism). In order to avoid inter-SFN interference, multiple localized MBMS service areas are separated from each other by guard area cells. FIG. 1 is a representation showing the relationship between SFNs in such a system. In FIG. 1, a first SFN 110 comprises a plurality of first SFN cells 115, and a second SFN 120 comprises a plurality of second SFN cells 125. The plurality of first SFN cells 115 and the plurality of second SFN cells 125 are separated by a plurality of guard cells 130. In this arrangement, both the first SFN 110 and the second SFN 120 use the same frequency band, but are not time-synchronized to each other. The MBMS services are not provided in the guard cells 130 in order not to cause interference with the first SFN cells 115 and the second SFN cells 125. This creates an outage area where user equipment (UE) cannot receive any MBMS services. This arrangement also creates an interruption period when the UE travels across the border between the first SFN 110 and the second SFN 120. In the event that a UE moves from the first SFN 110 to the second SFN 120, the MBMS services are terminated in the guard cells 130, and the UE therefore needs to resynchronize to the second SFN 120 in order to obtain the services. In order to improve the service quality of LTE-MBMS, it is important that this interruption time or period of service be reduced.

### SUMMARY OF THE INVENTION

Various embodiments comprise systems and methods for providing continuous MBMS services over different localized MBMS areas, while also avoiding the issue of frequency interference. According to various embodiments, in order to address the above issues, an MBMS service provides reduced-quality data at the border of each localized MBMS area. In one approach, border cells of a SFN broadcast reduced quality data, while center cells in a SFN broadcast full quality data. In another approach, the concepts of soft frequency reuse and layer coding are combined, such that source data is encoded into two layers—a baseline layer data stream and at least one enhancement layer data stream. In this approach, center cells in a SFN transmit both baseline and one or more enhancement layers. The frequency band of the SFN is split into one sub-band for baseline layer data and one or more sub-bands for enhancement layer data. In one SFN, the baseline data is transmitted in the same sub-band in center and borer cells. Border cells broadcast only the baseline layer, and non-overlapping sub-bands of bandwidth are used by neighboring cells to transmit the baseline layer. As a consequence, a piece of user equipment (UE) in a border cell does not receive interference from center cells of the same SFN when receiving baseline layer data. Further, UE in the border cells of one SFN does not receive interference from border cells of a neighboring SFN when receiving baseline layer data. In different embodiments, a single device or system can be used to allocate the necessary quality levels to the respective border cells and center cells, or border cells and center cells can be independently configured to the necessary allocations.

Various embodiments result in MBMS service continuation for guard cells between SFNs, while also resulting in a reduction in frequency interference. In certain embodiments, a frequency reuse-1 system is ensured for each SFN except for border cells, and MBMS service handover is also assisted by the implementation of these embodiments.

These and other advantages and features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a schematic representation of a pair of localized MBMS service areas with a plurality of guard cells therebetween;

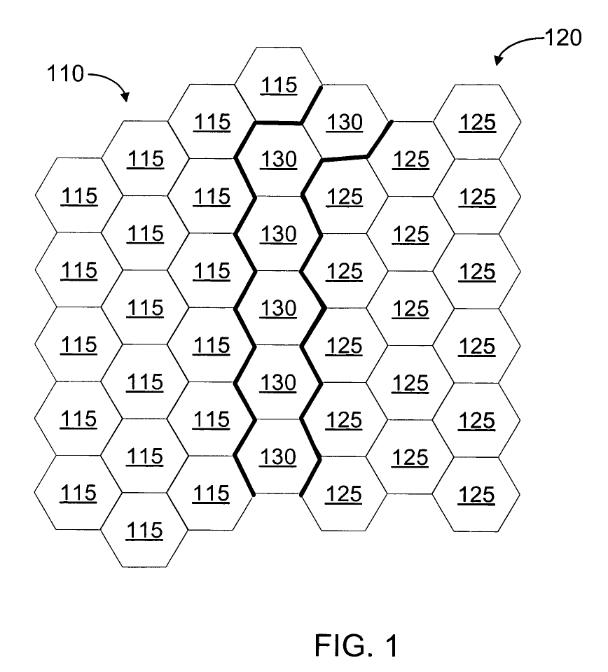

FIG. 2 is a schematic representation of three localized MBMS service areas constructed in accordance with various embodiments;

FIG. 3 is an examplary frequency arrangement for center and border cells of three neighboring SFNs in accordance with other embodiments, and FIG. 3(a) is a schematic representation showing how guard bands may be included between various allocated sub-bands for both center cells and border cells;

FIG. 4 is a message sequence chart showing the process by which a MBMS handover can occur with user equipment is in a border cell so that no service discontinuation occurs;

FIG. 5 is an overview diagram of a system within which various embodiments may be implemented;

FIG. 6 is a perspective view of an electronic device that can be used in conjunction with the implementation of various embodiments; and

FIG. 7 is a schematic representation of the circuitry which may be included in the electronic device of FIG. 6.

### DETAILED DESCRIPTION OF VARIOUS EMBODIMENTS

Various embodiments comprise systems and methods for providing continuous MBMS services over different localized MBMS areas, while also avoiding the issue of frequency interference. As mentioned previously, MBMS services are often used for the broadcast and multicast of multimedia data. Multimedia data is usually compressed from raw source data such as TV programs, music, voice communications and interactive games. For this data, the amount of data transmitted per second can be controlled by varying their qualities at the receiver side of the transmission. In other words, the necessary transmission bandwidth can be reduced by reducing the quality of the data being transmitted. There are a number of methods or algorithms that can be used to achieve this purpose. These methods include, for example, the layered coding, the use of different bits for representing color signals, and methods. Using color television broadcasts as an example, reducing the data bits used to represent the red, green and blue colors by 50% will not cause significant quality degradation when the picture is ultimately viewed by human eyes. In general, one third of the full data rate can still provide reasonable MBMS services in most situations.

In light of the above, various embodiments involve having the MBMS service at issue provide reduced-quality data at the border of each localized MBMS area. In different embodiments, a single device or system can be used to allocate the necessary quality levels to the respective border cells and center cells, or border cells and center cells can be independently configured to the necessary allocations.

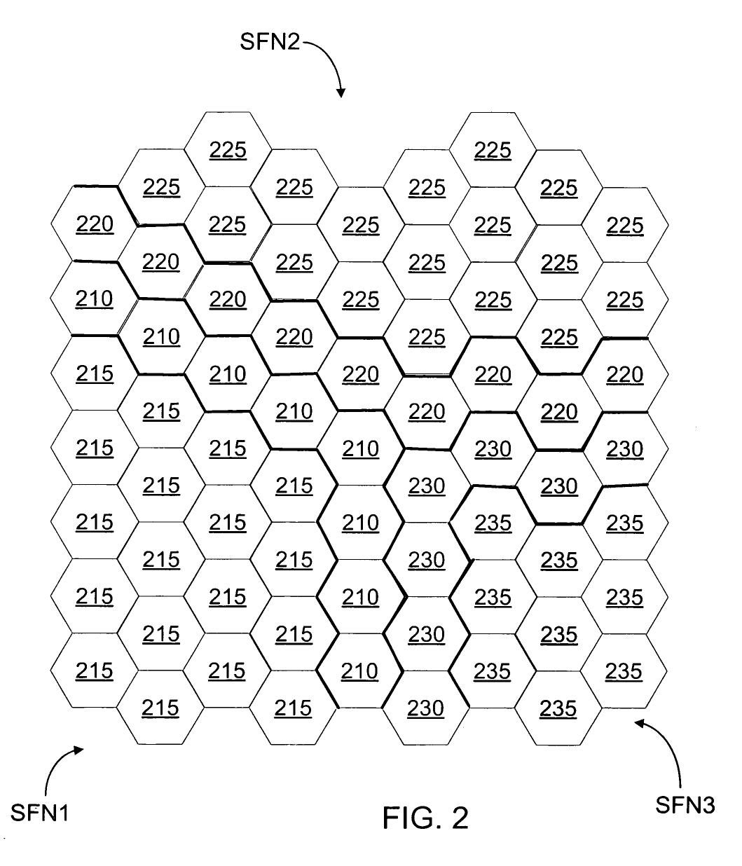

A number of approaches may be used to implement the various embodiments. In one embodiment, border cells of a SFN broadcast reduced-quality data, while center of the SFNs broadcast full quality data. Full quality data and reduced-quality data may be obtained independently from raw source data by varying their quality parameters and/or by using different algorithms. FIG. 2 is a representation of three localized MBMS service areas constructed in accordance with this particular embodiment.

In FIG. 2, there are three asynchronized SFNs: SFN1, SFN2 and SFN3. For each SFN, border cells are synchronized to center cells of the same SFN. More particularly, SFN1 border cells 210 are synchronized to SFN1 center cells 215; SFN2 border cells 220 are synchronized to SFN2 center cells 225; and SFN3 border cells 230 are synchronized to SFN3 center cells 235. In all of the SFN1, SFN2 and SFN3 center cells 215, 225 and 235, respectively, the MBMS may operate on the full bandwidth assigned to it with high quality services. In one embodiment, the high quality services comprise baseline layer data and one or more enhancement layer data. At the border of each SFN, however, the MBMS may operate on only a fraction of the bandwidth with reduced quality services. In an embodiment, the reduced quality service comprises only baseline layer data. For example, in the embodiment represented in FIG. 2, all SFN1 border cells 210 can operate at a first frequency (f1) representing one half of the full bandwidth, and all SFN2 border cells 220 can operate a second frequency (f2) representing one half of the full bandwidth. In the case of the SFN3 border cells 230, those cells that border only a SFN1 border cell 210 can operate at the second frequency f2, while those cells that border only a SFN2 border cell 220 can operate at the first frequency f1. For a SFN3 cell 230 that borders both a SFN1 border cell 210 and a SFN2 border cell 220, either f1 or f2 can be used, although some interference may result as discussed below.

Because border cells are synchronized to their SFN and use only a fraction of the frequency bandwidth, there is no intra-SFN interference. Additionally, because the border cells of different SFNs use different frequencies, there is no inter-SFN interference except at the small region representing the border of three SFNs. However, because the cell size is much smaller than the SFN size, the interfering area in this arrangement is very small.

Additionally, various mechanisms exist to address the inference in the region that is bordered by all three SFNs. One such mechanism involves, instead of splitting the full bandwidth in two for the various border cells, a reuse-3 arrangement may be used. In other words, each of the SFN border cells can be assigned only one-third of the full bandwidth instead of one-half of the bandwidth. As one third of the full data rate can still provide reasonable MBMS services in most situations, this arrangement provides a satisfactory result without sacrificing significant transmission quality.

In other embodiments, the concepts of soft frequency reuse and layer coding are combined. In these embodiments, source data is coded by two or more layers, comprising a baseline layer and at least one enhancement layer. In these embodiments, the whole bandwidth of one cell is divided into two or more portions, with some bandwidth being used to transmit the baseline layer data and other portions of the bandwidth to transmit the enhancement layer(s) data. In this arrangement, center cells for the SFN broadcast both the baseline and enhancement layer(s) data. However, border cells only broadcast the baseline layer data. In one SFN, the baseline layer data is transmitted in the same sub-band in center and border cells. Furthermore, the sub-band for use in transmitting the baseline layer varies by SFN, such that the same sub-band is not used by neighboring SFNs. As a result, a UE located at a cell border will still obtain enough combination gain from the transmission of center cells when receiving the baseline stream, but will not get strong interference from neighboring cells. In these embodiments, a UE may receive signaling concerning baseline and enhancement layer availability, decode the baseline and enhancement layers based upon availability or desire by the UE, combine the decoded layered information, and render the resulting content.

In certain embodiments, between the sub-bands that are allocated for the baseline layer data and one or more enhancement layer data of the MBMS services, there may be one or more portions of the bandwidth that are not allocated for the MBMS services. This sub-band may be used for other purposes or remain partially or wholly unused. Such a guard band or guard bands may further reduce the interference from neighboring cells. In one embodiment, these guard bands may be provided between the sub-bands that have been allocated for baseline layer data and the one or more sub-bands that have been allocated for enhancement layer data.

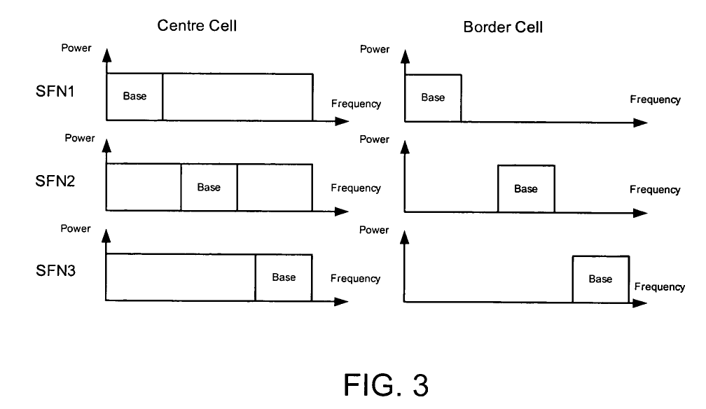

FIG. 3 illustrates one example of the frequency arrangement for centre and border cells of three neighboring SFNs according to these embodiments. As shown in FIG. 3, for each SFN, all center cells broadcast both baseline and enhancement layers. In the case of the border cells, these cells only broadcast the baseline layer. A UE that is located within a center cell can receive both baseline and enhancement layers, while also getting SFN gain (i.e., signal combination gain from neighboring cells) for both layers. For a UE in a border cell, the UE may only receive the baseline layer but can still get SFN gain for the baseline layer. Various methods may be used to implement the layered coding arrangements discussed herein. FIG. 3(a) is a schematic representation showing how a plurality of guard bands (G) can be strategically placed between a baseline layer (B) and an enhancement layer (Ex), or between enhancement layers.

In one particular embodiment, the baseline layer data and the enhancement layer data are encoded independently, and the UE decodes them independently and then combines the baseline layer data with some or all of the enhancement layer data in order to obtain the desired quality content. In another embodiment, the enhancement layer data encoding is dependent upon the baseline layer data encoding. In this embodiment, the baseline layer data is decoded independently in the UE. The enhancement layer data is decoded depending on the baseline layer data decoding. The decoded baseline and enhancement layer data are again combined in the UE for desired quality content.

In a further embodiment, the UE in a center cell may set a desired quality service by selecting one or more enhancement layers. In another embodiment, some of the enhancement layers may be transmitted in all, some or none of the border cells. If any enhancement layer data is transmitted in the border cells, this data may be signaled, and the UE may select to receive enhancement layer data in addition to the baseline layer data. If one or more sub-bands are allocated for one or more enhancement layers within the border cells, then the allocation of sub-bands should not overlap with the sub-band allocations in neighboring SFN border cells.

Depending on the interference level, a network planner can also dynamically adjust the number of border cells. For example, a network planner can stop the transmission of enhancement layers on some or all of those cells that are located adjacent to border cells, i.e., the planner can increase the border cells from one ring to two rings, if strong inter-SFN interference is detected.

In one particular embodiment, a particular MBMS coordination entity (MCE) of one SFN may signal the availability of the base layer only vs. the availability of both the base layer and enhancement layers, to the UE in various forms. This type of information may be signaled, for example, within network information, cell information, and/or service information. The information may be signaled in a control channel or as part of network, cell and/or service information signaling, including service discovery and service announcement information. The MCEs of neighboring SFNs may, in one embodiment, negotiate the sub-band allocations in border cells.

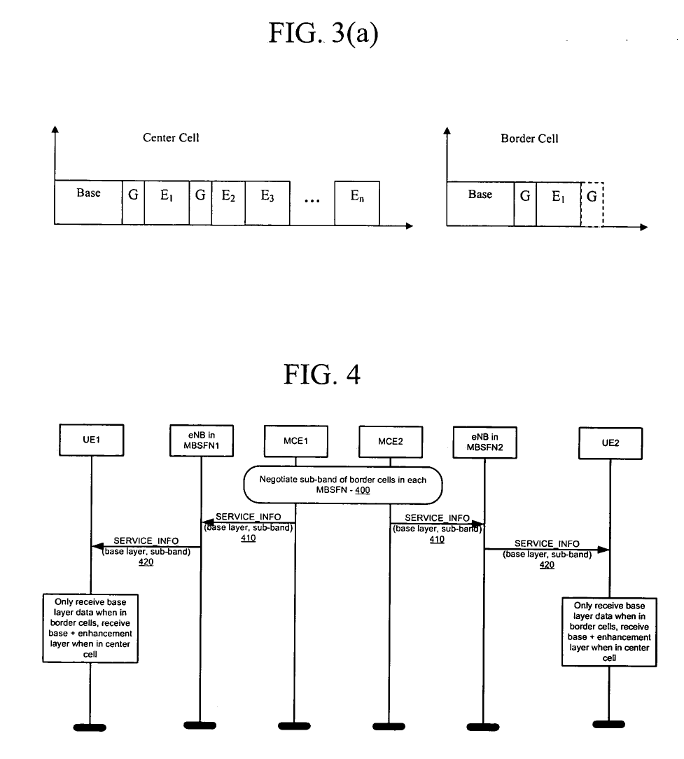

In various embodiments, information can be provided to enable MBMS service handovers when UEs are within border cells in order to prevent service interruptions and/or discontinuations. FIG. 4 is a message sequence chart showing one processes by which such handovers can be effectuated. In FIG. 4, it is assumed that one multimedia broadcast SFN (MBSFN) is managed by one MBMS Coordination Entity (MCE). Before the session starts, two or more MCEs (represented as MCE1 and MCE2 in FIG. 4) may negotiate how the sub-bands should be used to transmit base layer data in each MBSFN. This representation is represented at 400 in FIG. 4. After the negotiation is complete, each MCE informs base stations, in one embodiment 3GPP LTE base stations known as evolved Node Bs,(eNBs) at 410 of which sub-bands are used to transmit base layer data in a SERVICE_INFO message. In one embodiment, eNBs then transmit this message at 420 to UE in a control channel, for example in a multicast control channel (MCCH). In one embodiment, this message can be transmitted in a single cell MCCH channel, meaning that each eNB in a MBSFN may transmit different messages. In this case, border cells broadcast availability information regarding baseline layer data, and center cells broadcast the availability information regarding both baseline and enhancement layer data. In another embodiment, this message can be transmitted in a multi cell MCCH channel, meaning that all eNBs in a MBSFN transmit the same message. In this case, that UE is aware of available layers of data in border and center cells. The UE detects its location in a MBSFN (border or center) and then decides the proper layers to receive.

The SERVICE_INFO message can be transmitted as part of a MBMS SESSION START message. Based on the received sub-band information, each UE can decide whether to receive full quality contents (i.e., base and enhancement layer data) or reduced quality contents (i.e., only base layer data). In one particular embodiment, it is also possible for a single MCE to manage all MBSFNs. In such a case, this MCE may decide the sub-band allocation by itself and may separately inform eNBs in each MBSFN.

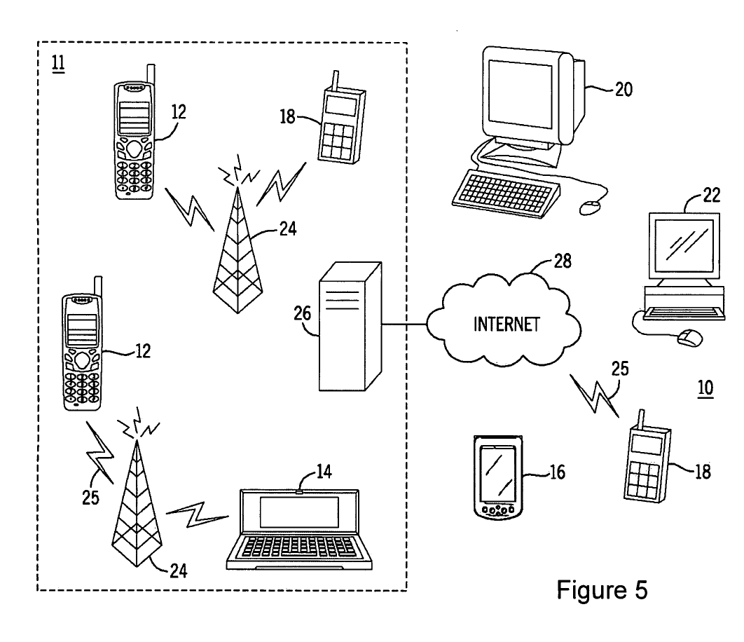

FIG. 5 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 50, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

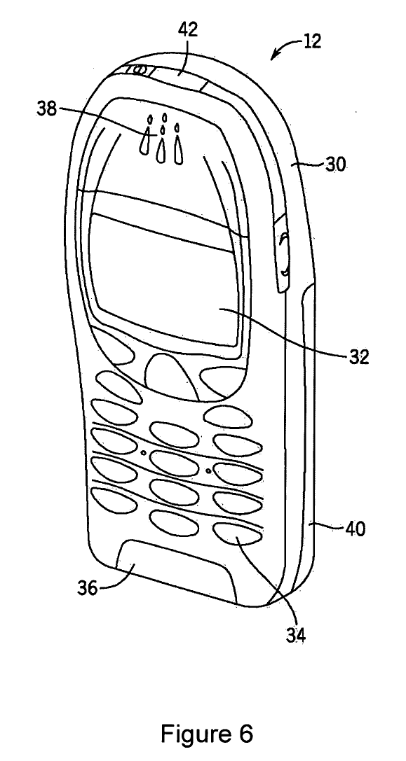

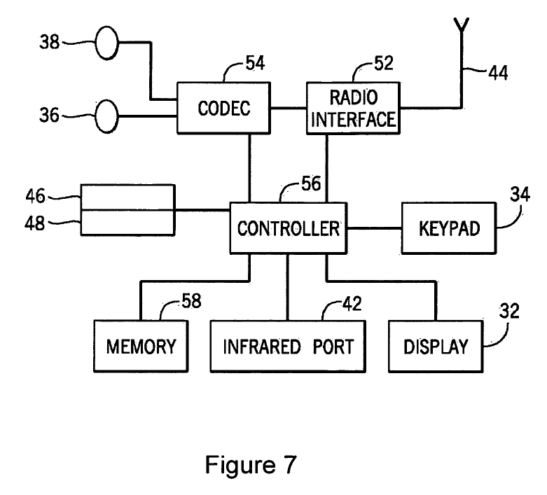

FIGS. 6 and 7 show one representative electronic device 50 within which various embodiments may be implemented. It should be understood, however, that the various embodiments are not intended to be limited to one particular type of device. The electronic device 50 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

The various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments have been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated.

What is claimed is:

1. A method, comprising:
providing a single frequency network including at least one center cell and at least one border cell, each of the at least one border cell being closer to an adjacent single frequency network than each of the at least one center cell;
allocating a first quality level for the transmission of data from each of the at least one center cell; and
allocating a second quality level for the transmission of data from each of the at least one border cell, the second quality level being less than the first quality level.

2. The method of claim 1, wherein the allocating of the first quality level comprises allocating, to each of the at least one center cell, the entire bandwidth assigned to the single frequency network, and wherein the allocating of the second quality level comprises allocating, to each of the at least one border cell, a sub-band consisting of less than the entire bandwidth assigned to the single frequency network.

3. The method of claim 2, wherein the allocated sub-band comprises one half of the bandwidth assigned to the single frequency network.

4. The method of claim 2, wherein the allocated sub-band comprises one third of the bandwidth assigned to the single frequency network.

5. The method of claim 2, wherein, for each border cell, the allocated sub-band is different than sub-bands used by any neighboring border cells from adjacent single frequency networks.

6. The method of claim 1, wherein the allocating of the first quality level comprises permitting each of the at least one center cell to transmit both baseline and enhancement layer data, and wherein the allocating of the second quality level comprises permitting each of the at least one border cell to transmit only baseline layer data.

7. The method of claim 6, wherein the allocating of the first and second quality levels further comprises allocating, for the transmission of the baseline layer data, a sub-band of bandwidth allocated to the single frequency network.

8. The method of claim 7, wherein the allocated sub-band comprises a sub-band that is different from sub-bands allocated to center cells and border cells from adjacent single frequency networks.

9. A computer program product, embodied in a computer-readable medium, comprising computer code configured to perform the processes of claim 1.

10. An apparatus, comprising:
a processor; and
a memory unit communicatively connected to the processor and including:
for a single frequency network including at least one center cell and at least one border cell, each of the at least one border cell being closer to an adjacent single frequency network than each of the at least one center cell, computer code for allocating a first quality level for the transmission of data from each of the at least one center cell; and
computer code for allocating a second quality level for the transmission of data from each of the at least one border cell, the second quality level being less than the first quality level.

11. The apparatus of claim 10, wherein the computer code for allocating the first quality level comprises computer code for allocating, to each of the at least one center cell, the entire bandwidth assigned to the single frequency network, and wherein the computer code for allocating the second quality level comprises computer code for allocating, to each of the at least one border cell, a sub-band consisting of less than the entire bandwidth assigned to the single frequency network.

12. The apparatus of claim 11, wherein the allocated sub-band comprises one half of the bandwidth assigned to the single frequency network.

13. The apparatus of claim 11, wherein the allocated sub-band comprises one third of the bandwidth assigned to the single frequency network.

14. The apparatus of claim 11, wherein, for each border cell, the allocated sub-band is different than sub-bands used by any neighboring border cells from adjacent single frequency networks.

15. The apparatus of claim 10, wherein the computer code for allocating the first quality level comprises computer code for permitting each of the at least one center cell to transmit both baseline and enhancement layer data, and wherein the computer code for allocating the second quality level comprises computer code for permitting each of the at least one border cell to transmit only baseline layer data.

16. The apparatus of claim 15, wherein the computer code for allocating of the first and second quality levels further comprises computer code for allocating, for the transmission of the baseline layer data, a sub-band of bandwidth allocated to the single frequency network.

17. The apparatus of claim 16, wherein the allocated sub-band comprises a sub-band that is different from sub-bands allocated to center cells and border cells from adjacent single frequency networks.

18. An apparatus, comprising:
in a single frequency network including at least one center cell and at least one border cell, each of the at least one border cell being closer to an adjacent single frequency network than each of the at least one center cell, means for allocating a first quality level for the transmission of data from each of the at least one center cell; and
means for allocating a second quality level for the transmission of data from each of the at least one border cell, the second quality level being less than the first quality level.

19. The apparatus of claim 18, wherein the means for allocating the first quality level comprises means for allocating, to each of the at least one center cell, the entire bandwidth assigned to the single frequency network, and wherein the means for allocating the second quality level comprises means for allocating, to each of the at least one border cell, a sub-band consisting of less than the entire bandwidth assigned to the single frequency network.

20. The apparatus of claim 19, wherein, for each border cell, the allocated sub-band is different than sub-bands used by any neighboring border cells from adjacent single frequency networks.

21. The apparatus of claim 18, wherein the means for allocating the first quality level comprises means for permitting each of the at least one center cell to transmit both baseline and enhancement layer data, and wherein the means for allocating the second quality level comprises means for permitting each of the at least one border cell to transmit only baseline layer data.

22. The apparatus of claim 21, wherein the means for allocating the first and second quality levels further comprises means for allocating, for the transmission of the baseline layer data, a sub-band of bandwidth allocated to the single frequency network.

23. The apparatus of claim 22, wherein the allocated sub-band comprises a sub-band that is different from sub-bands allocated to center cells and border cells from adjacent single frequency networks.

24. A system, comprising:
a single frequency including:
at least one center cell; and
at least one border cell, each of the at least one border cell being closer to an adjacent single frequency network than each of the at least one center cell,
wherein the at least one center cell is configured to transmit data at a first quality level, and wherein the at least one border cell is configured to transmit data at a second quality level, the second quality level being less than the first quality level.

25. The system of claim 24, wherein the first quality level comprises use of the entire bandwidth assigned to the single frequency network, and wherein the second quality level comprises use of a sub-band consisting of less than the entire bandwidth assigned to the single frequency network.

26. The system of claim 25, wherein, for each border cell, the sub-band is different than sub-bands used by any neighboring border cells from adjacent single frequency networks.

27. The system of claim 25, wherein the sub-band comprises one half of the bandwidth assigned to the single frequency network.

28. The system of claim 25, wherein the sub-band comprises one third of the bandwidth assigned to the single frequency network.

29. The system of claim 24, wherein the first quality level comprises use of both baseline and enhancement layer data, and wherein the second quality level comprises use of only baseline layer data.

30. The system of claim 29, wherein the baseline layer data is transmitted over a specific sub-band of bandwidth that has been allocated to the single frequency network.

31. The system of claim 30, wherein the sub-band is different from sub-bands used for transmission of baseline layer data in adjacent single frequency networks.

32. A method, comprising:
receiving signaling concerning availability of baseline and enhancement layers;
at least selectively decoding available baseline and enhancement layers;
combining the decoded baseline and enhancement layers; and
rendering the combined, decoded baseline and enhancement layers.

33. The method of claim 32, wherein all available baseline and enhancement layers are decoded.

34. The method of claim 32, wherein only desired baseline and enhancement layers are decoded.

35. An apparatus, comprising:
a processor; and
a memory unit communicatively connected to the processor and including:
computer code for processing received signaling concerning availability of baseline and enhancement layers;
computer code for at least selectively decoding available baseline and enhancement layers;
computer code for combining the decoded baseline and enhancement layers; and
computer code for rendering the combined, decoded baseline and enhancement layers.

36. The apparatus of claim 35, wherein all available baseline and enhancement layers are decoded.

37. An apparatus, comprising:
means for processing received signaling concerning availability of baseline and enhancement layers;
means for at least selectively decoding available baseline and enhancement layers;
means for combining the decoded baseline and enhancement layers; and
means for rendering the combined, decoded baseline and enhancement layers.

38. The apparatus of claim 35, wherein all available baseline and enhancement layers are decoded.
